(19) United States
(12) Patent Application Publication
(10) Pub. No.: US 2022/0311245 A1
(43) Pub. Date: Sep. 29, 2022

(54) METHOD FOR FEEDING ELECTRICAL POWER INTO AN ELECTRICAL SUPPLY NETWORK

(71) Applicant: Wobben Properties GmbH, Aurich (DE)

(72) Inventor: Johannes Brombach, Berlin (DE)

(21) Appl. No.: 17/706,431

(22) Filed: Mar. 28, 2022

(30) Foreign Application Priority Data
Mar. 29, 2021 (EP) 21165563.4

(51) Int. Cl. H02J 3/24; H02J 3/38

(52) U.S. Cl. CPC H02J 3/24; H02J 3/381; H02J 2300/28

(57) ABSTRACT

Provided is a method for feeding electrical power into an electrical supply network using infeed systems. Each infeed system feeds a system infeed current into the network via a connection node, and each infeed installation outputs an installation current. A respective system path is between each infeed system and a reference point in the network. A respective installation path is between each infeed installation and the reference point in the network. The system paths have a common section between a connecting node and the reference point, and the system infeed currents add to form a total current. Control of the system infeed current and the installation current depends on a phase angle shift and/or a voltage drop between the infeed system and the reference point and the infeed installation and the reference point, respectively. The phase shift or the voltage drop is ascertained depending on the total infeed current.

### BACKGROUND

### Technical Field

The present invention relates to a method for feeding electrical power into an electrical supply network by means of a plurality of infeed systems. The invention also relates to corresponding infeed systems. The invention also relates to an infeed system of such an arrangement of infeed systems and the invention also relates to an infeed installation of such an infeed system.

### Description of the Related Art

Infeed systems are known; they feed electrical power into an electrical supply network. Particularly regenerative energy sources, such as wind power installations and photovoltaic installations, but also electrical storage systems use converters or inverters for infeed. Such converters often operate in a current-impressing manner, that is to say they feed in a specifiable current, which is thus impressed. The term “converter” subsequently also always includes the term “inverter.”

In current-impressing converters, the separate current fed in influences the voltage reference. Variations of the current fed in thus lead to variations of the voltage, to which the respective infeed system or the respective infeed installation refer. If a network impedance is very high, small power fluctuations can lead to large changes in the phase position of the voltage reference, which in turn require an adjustment of the current infeed. This can lead to instabilities when such an adjustment or change of the current infeed is counter-controlled and such counter-control leads to a great influence on the reference.

In order to prevent such instabilities, provision may be made for controllers that feed in current to be operated only up to a particular short-circuit power ratio, which can also be referred to as short-circuit current ratio.

The short-circuit current ratio, which is also abbreviated to SCR, is the ratio between the short-circuit power and the connection power. Short-circuit power is understood here to be that power that the relevant supply network can provide at the network connection point under consideration, at which the infeed system is intended to be connected, when a short circuit arises there. The connection power is the connection power of the infeed system to be connected, in particular the nominal power of the infeed system to be connected. That is to say, when the connection topology of the electrical supply network to the network connection point under consideration is present, a large short-circuit current ratio can therefore be achieved only by means of a low connection power. In other words, particularly regenerative energy sources can then be connected only in a correspondingly low range.

Such a network connection point with a low short-circuit current ratio, in particular one that is less than 2, is also referred to as a weak network connection point. If a correspondingly high-power infeed system is still intended to be connected to such a weak network connection point, the network topology would have to be changed. That is to say, in particular lines with a lower impedance would have to be placed in order to reduce the network impedance as a result. However, such measures are very costly.

For example, document U.S. Pat. No. 10,132,294 B2 considers a virtual voltage measurement point in order to obtain a more stable reference value. Here, provision is made in particular for this virtual voltage measurement point to be moved into the windings of a transformer and for the voltage of this virtual measurement point to be calculated. As a result, a better voltage base is intended to be provided.

However, the problem of a low short-circuit current ratio is not addressed here, nor are instabilities of the controller that potentially arise as a result.

### BRIEF SUMMARY

Ensuring stable operation of at least one infeed system at a weak network connection point is provided herein.

A method is proposed. Accordingly, a method for feeding electrical power into an electrical supply network by means of a plurality of infeed systems is provided. An infeed system can be designed as an individual infeed installation, in particular as a wind power insulation, or as an infeed farm having a plurality of infeed installations, in particular as a wind farm having a plurality of wind power installations. In particular, a plurality of wind farms, which each have a plurality of wind power installations, are therefore provided. However, such a wind farm can also additionally contain other feeders, in particular an energy store (e.g., battery). Consideration is also given to a connection to other feeders, such as photovoltaic installations, for example. In the preferred embodiment, however, the main emphasis is on the wind power installations.

In principle, the infeed system can be provided as an individual wind power installation, with the result that each wind power installation feeds electrical power into the electrical supply network.

Since a plurality of infeed systems are provided, a plurality of wind power installations are then accordingly present. However, the preferred application consists in each infeed system forming a respective wind farm having a plurality of wind power installations. In this case, it is particularly important that such a wind farm having a plurality of wind power installations, such as having 10 or more wind power installations up to 50 or still more wind power installations, for example, has a high connection power and thus also a great influence on the behavior of the electrical supply network, at least at a network connection point.

Each infeed system feeds a system infeed current into the electrical supply network in each case via a connection node. Since a plurality of infeed systems are provided, a plurality of connection nodes are therefore also provided. A connection node may be a network connection point, such that in particular a plurality of network connection points are present. However, consideration is also given to the fact that a plurality of connection nodes are combined by means of corresponding current paths in order then to feed into the electrical supply network via a common network connection point. This is particularly taken into account when a plurality of infeed systems together form a wind farm, such that the respective connection node forms a node still within the wind farm.

Each infeed installation, that is to say in particular each wind power installation, outputs an installation current. A system infeed current therefore corresponds to an installation current when the relevant infeed system corresponds to the infeed installation or a system infeed current is made up of a plurality of installation currents when the infeed system also has a plurality of infeed installations. A system infeed current is therefore the sum of all installation currents of the infeed installations of said infeed system.

A respective system transmission path for transmitting electrical power is present between each of the infeed systems and a reference point in the electrical supply network, with the result that the system infeed current is transmitted on each system transmission path. Furthermore, a respective installation transmission path for transmitting electrical power is present between each infeed installation and the reference point in the electrical supply network, with the result that the installation current is transmitted on each installation transmission path.

If, for example, in each case two wind farms, which each have two wind power installations as infeed installations, are present as infeed systems, there are therefore four wind power installations, that is to say four infeed installations, present and thus four installation transmission paths. Two system transmission paths are present at the same time. These installation transmission paths and system transmission paths partly coincide and ultimately all lead to the one reference point in the electrical supply network.

The system transmission paths have a common path section between a connecting node and the reference point, on which common path section the system infeed currents add up to form a total infeed current. All of the installation currents therefore add up there to form the total infeed current. It is therefore not only the system transmission paths together that arise in said common path section but also all of the installation transmission paths. The connecting node can therefore form the node at which all of the currents come together. All of the currents that come together at the connecting node can therefore also be referred to as node currents.

Furthermore, provision is made for each infeed system, or at least one infeed system, to control its system infeed current depending on a phase angle shift and/or a voltage drop between the infeed system and the reference point. In addition or as an alternative, provision is made for each infeed installation, or at least one infeed installation, to control its current depending on a phase angle shift and/or a voltage drop between the infeed installation and the reference point. The method makes provision in particular for each infeed system or each infeed installation to operate as described in order to exploit the potential described herein as fully as possible but if not all of said infeed systems or infeed installations are involved, an advantageous effect can still be achieved by the others that implement the method. In this case, where possible, the currents of the infeed systems or infeed installations that are not involved should also be taken into account.

In any case, a phase angle shift between the connecting node and the reference point is therefore observed and in addition or as an alternative a voltage drop between the connecting node and the reference point is observed. Both of these depend on the current on the common path section. Said current is the sum of all of the system infeed currents and thus also the sum of all of the installation currents. The control of the infeed system or the control of a system infeed current and also the control of the infeed installation or the installation current thereof therefore depends in each case on all of the system infeed currents or on all of the installation currents. If still other currents are to be fed in by other generators or are consumed by other consumers on the common path section, these and the effects thereof would additionally need to be taken into account.

For the sake of simplicity, it is possible initially to consider the case that only these system 5 infeed currents or installation currents flow on the common path section. It is therefore proposed that the phase shift or the voltage drop is ascertained in each case depending on the total infeed current. The phase shift or the voltage drop is therefore ascertained depending on all of the installation currents or all of the system infeed currents.

As a result, the effect of all of these currents up to the reference point can be taken into account. The voltage at the reference point should be substantially and/or mostly stable. Through good knowledge of all of these currents or the effects thereof, the less stable voltages at the infeed systems or at the infeed installations can be used to infer said voltage at the reference point with a good degree of accuracy. As a result, the infeed systems or infeed installations can be guided by a stable voltage at the reference point. In particular, it has been identified that operation at extremely 15 weak network connection points may require stable knowledge of the reference. It is therefore possible here to detect and take into account stable knowledge of the voltage at the reference point and/or of the phase angle at the reference point. As a result, stable control of the currents to be fed in is possible.

In this case, it has in particular also been identified that taking into account an infeed system alone, that is to say in particular only taking into account a single infeed current, can lead to unstable control because the effects of the voltage changes of the other infeed currents are not taken into account even though they are often not negligible. A solution to the mentioned problem is provided by observing the overall resulting phase shift or the overall resulting voltage drop and therefore taking into account the total infeed current. Now, the overall effect on the phase shift or the voltage drop can be taken into account in the control and thus stable control upon infeed can be achieved. It is thus possible to achieve overall stable infeed even in the case of very weak network connection points.

According to one aspect, it is proposed that each connection node is designed as a network connection point, and/or the infeed systems and the infeed installations operate in a manner controlled by converters and in a current-impressing manner.

As a result of the fact that each connection node is designed as a network connection point, infeed systems that feed into the electrical supply network at different network connection points are thus considered. For this configuration, it is therefore proposed that the system infeed currents that are thus fed in at different network connection points are taken into account. Said system infeed currents thus add up first in the electrical supply network to form a total infeed current, specifically in particular at the connecting node, and it is still proposed to take them into account, at least by means of the total infeed current. This therefore also means that the connecting node is arranged in the electrical supply network, that is to say between the reference point and the network connection points.

In this case, it has been identified that the behavior of the corresponding section in the electrical supply network may be relevant depending on the respective current and that this is taken into account accordingly. Taking this into consideration thus makes it necessary to take into account the effect that arises through the addition of the system infeed currents in the electrical supply network.

In particular, because of this, infeed systems and infeed installations that operate in a manner controlled by converters and in a current-impressing manner are used and thus taken into account. Said infeed systems or infeed installations therefore each specify an infeed current. This leads to a corresponding voltage at the corresponding path or a change in the respective specified infeed current leads to a corresponding voltage of the corresponding current path. However, these changes depend not only on the current fed in but also on the other currents fed in that ultimately add up to form the total infeed current.

It has also been identified that it is expedient to control this current-impressing infeed, that is to say the specification of the respective infeed current, in terms of the voltage response. In this case, it is not only the voltage response of the respective infeed current to be controlled that is taken into account but also the voltage response that results through the other infeed currents. This overall consideration provides a targeted specification of the infeed current while maintaining the stability. It is thus possible in principle to feed in a comparatively large amount of power but one which does not have to lead to instability on account of taking the voltage effects into account in a targeted manner. As a result, it is possible to achieve infeed given a low short-circuit current ratio.

It is therefore advantageous if all of the infeed installations and thus all of the infeed systems operate in a manner controlled by converters and in particular in a current-impressing manner. However, the proposed advantage can of course also be achieved if an infeed installation that feeds in in a voltage-impressing manner, or a plurality thereof, is included. The described aim is particularly easy to achieve if the current-impressing operation at least dominates.

It is proposed for at least 50% of the infeed installations to operate in a current-impressing manner, in relation to the nominal power thereof, in particular for at least 80% of the infeed installations to operate in a current-impressing manner in relation to the nominal power thereof. As a result, this effect can be achieved because the current-impressing operation can then be sufficiently dominant.

According to one aspect, it is proposed that at least one of the infeed systems controls its system infeed current depending on the phase angle shift and/or depending on the voltage drop between the infeed system and the reference point by virtue of each infeed installation of the infeed system controlling its installation current depending on a phase angle shift and/or a voltage drop between the respective infeed installation and the reference point. In this case, it is thus proposed in particular that the infeed installations implement the control. To this end, said infeed installations can take their own installation current and the installation currents of the other infeed installations into account or else take other, possibly already combined currents, or the system infeed currents into account.

Particularly when taking all of the other installation currents into account, extensive communication between the infeed installations may be expedient. As a result thereof, a comparatively great communication outlay can arise, but this can be justified by the aim that is sought for. An advantage of the use of the infeed installations, that is to say in particular the wind power installations that feed in, is that they can possibly react more quickly to network reactions or else network incidents than if a central control system additionally had to be used in each infeed system. If the infeed system is a wind farm, such a central control system may thus be a wind farm controller or may be implemented on a wind farm controller.

The infeed installations then know for example all of the installation currents and can still react very quickly based on this knowledge when a voltage event arises in the network or else a frequency event that requires a reaction. Particularly on the assumption that the other infeed installations perceive such a voltage event and/or frequency event in the same manner or a similar manner as the other infeed installations and also react in the same or similar manner, this behavior and thus an expected change in all of the installation currents can be anticipated accordingly during the control.

By using the infeed installations to control the proposed infeed, in any case a very quick and at the same time well-controlled reaction is therefore possible. According to one aspect, it is proposed that, in order to detect the phase angle shift or the voltage drop depending on the total infeed current, information about the system infeed currents is exchanged between the infeed systems and/or information about the installation currents is exchanged between the infeed installations and/or the total infeed current is detected metrologically. Particularly when the infeed systems control the infeed, they can exchange corresponding information relating to the system infeed currents among one another. This prevents the need to additionally add a corresponding current sensor. A particular advantage when using current impression, which is to be understood here as a general statement, is also that a corresponding system infeed current or installation current is detected anyway for said current impression depending on where said current impression is carried out. As a result, there is a good value that then needs to be communicated only between the infeed systems.

The same applies when information about the installation currents is exchanged between the infeed installations. The infeed installations mostly know their own installation current and, in particular when they operate in a current-impressing manner, they detect said installation current in order to be able to control the current impression accordingly. The current is thus known and corresponding information only needs to be exchanged.

In particular, and this applies for all aspects, a tolerance band method is used for infeed. In said tolerance band method, the current fed in is detected continuously and this can be taken into account accordingly, in particular can be exchanged between the infeed installations.

Nevertheless, it is also possible to detect the total infeed current metrologically. To this end, corresponding metrological outlay is required, but this can be justified according to the situation.

Particularly when infeed systems with a high power are connected to comparatively weak network sections such that a low short-circuit current ratio results, the provision of a corresponding current sensor or a plurality of current sensors may be comparatively expedient in comparison to an otherwise required upgrading of the network section in question in order to increase the short-circuit current ratio as a result.

According to one aspect, it is proposed that a phase angle sensitivity is determined for each infeed system and/or for each infeed installation, said phase angle sensitivity indicating a ratio between a change in the system infeed current or the installation current and the resulting phase angle shift. To this end, it is also proposed that the system infeed current or the installation current is controlled in each case depending on the respectively detected phase angle shift and the respectively determined phase angle sensitivity. The phase angle sensitivity thus describes how sensitively the phase angle reacts to a change in the system infeed current. The phase angle sensitivity can be given, for example, in degrees when it relates to a standardized change in the system infeed current or installation current. The change in the system infeed current or the installation current can be standardized to a nominal value of the system infeed current in question or the installation current in question. That is to say if the phase angle sensitivity is 10 degrees, for example, this means that the phase angle changes by 10 degrees when the system infeed current or the installation current changes from zero to the nominal value in question, or vice versa.

In particular, the control can be provided so that the phase angle shift is taken into account as input variable and the system infeed current or the installation current is adjusted depending thereon, while the taking into account of the phase angle sensitivity is taken into account by means of an adjustment of the control dynamics. In particular, it is proposed that the system infeed current or the installation current is controlled depending on the phase angle shift by means of current control with a controller gain and that the controller gain is reduced in terms of magnitude as the phase angle sensitivity increases. Given a high phase angle sensitivity, such current control therefore reacts somewhat more softly or conservatively. Given a low phase angle sensitivity, it can react more strongly. This prevents in particular instability being achieved, specifically too strong a reaction of the voltage being achieved at the reference point, due to too strong a controller reaction of the current control in the case of a weak network or low short-circuit current ratio at which a higher phase angle sensitivity occurs. An overreaction is therefore avoided.

In this case, it has been identified that such a phase angle sensitivity may be dominated in particular by a common network section and thus in particular by the common path section between connecting nodes and reference point. This is due in particular to the fact that the lines at least between each infeed system or the infeed installations on the one hand and the connection node on the other hand are well developed since they are often constructed together with the corresponding infeed system or the infeed installations and are therefore seldom dimensioned to be too weak.

This can lead to the phase angle sensitivities between the infeed systems or the infeed installations being relatively similar. This in turn leads to each infeed system or each infeed installation that takes its phase angle sensitivity into account therefore also taking the other phase angle sensitivities into account. In other words, it is often necessary to plan on all of the phase angle sensitivities being similarly strong or similarly weak. Accordingly, all of the infeed systems or infeed installations have matched their control to approximately identically high or identically low, that is to say identically strong or identically weak, phase angle sensitivities.

In order to improve this simplistic assumption, consideration is preferably given to exchanging information about phase angle sensitivities between the infeed systems or between the infeed installations.

According to one aspect, it is proposed that the system infeed current and/or the installation current is controlled in each case in such a way that the phase angle shift satisfies at least one shift limit criterion. In this case, consideration is given in particular to the phase angle shift being detected accordingly and the control being adapted when a shift limit criterion is reached or indicates a profile that a shift limit criterion could be exceeded without intervention.

In particular, it is proposed that the phase angle shift in terms of magnitude does not exceed a maximum shift value. The maximum shift value is therefore an absolute limit value that is specified for the phase angle shift as an upper limit in terms of magnitude. If the system infeed current or installation current is thus increased in such a way that a phase angle shift that threatens to exceed said maximum value increases, the infeed of the system infeed current or the installation current can be reduced or otherwise adjusted accordingly.

In the simplest case, an increase in the current infeed is stopped at the moment at which the phase angle shift reaches the limit value. However, reaching a limit value in this way can also be identified beforehand. If, for example, the infeed current is increased based on a time-dependent ramp, the phase angle shift accordingly increases in a manner proportional thereto and it is therefore easy to be able to identify which maximum value the phase angle shift reaches when the current fed in has reached the end of said ramp.

In addition or as an alternative, provision is made for the phase angle shift in terms of magnitude not to exceed a maximum shift rate of change. A maximum shift rate of change of this kind is therefore a shift limit criterion. That is to say, staying with the example, if the current fed in increases according to a ramp, this leads to a phase angle shift according to a proportional ramp. If the gradient of this ramp is too high in terms of magnitude, the ramp of the current fed in can be flattened accordingly in order to flatten the ramp of the phase angle shift.

All of these limits can of course also be taken into account in the case of negative changes, both for the absolute values and for the consideration of the change rate. The maximum values or the phase angle shifts to be examined in terms of magnitude are therefore considered. It is thus also unfavorable if the phase angle shift decreases too greatly or too rapidly.

These limit specifications can be used to prevent too great or too rapid a change in the phase angle shift and thus too great or too rapid a change in the relevant phase angle at the reference point. This addresses in particular a problem that can arise in the case of weak network sections, in particular specifically in the case of low short-circuit current ratios. In this case, the solution nevertheless makes possible the greatest possible current infeed and therefore the connection of the largest possible infeed systems or infeed installations.

According to one aspect, it is proposed that the control of the system infeed currents and/or the installation currents is coordinated centrally. This makes it possible to achieve a situation in which all of the relevant currents, that is to say system infeed currents or installation currents, are not only taken into account but also controlled and the overall reaction of the voltage, in particular at the reference point, or the voltage drop and/or the phase angle shift can be controlled accurately. As a result, a high degree of stability can be achieved while at the same time a comparatively large amount of power can be fed in or comparatively large infeed systems or infeed installations can be connected in the case of a low short-circuit current ratio.

Central control of this type can be carried out for example in such a way that in each case one central farm control system (e.g., central farm controller) is present in each infeed system, in particular wind farm, and these farm control systems are coordinated among one another. In this case, one of the farm control systems for controlling the system infeed currents or installation currents can take over a superordinate control system. Implementation of a central control system of this type can be achieved by virtue of corresponding actual values, particularly of the currents but also of the relevant voltage, being collected in said central control system and setpoint values being provided to the individual infeed systems or infeed installations depending thereon. It is also possible to provide a cascaded structure in which a central control unit provides setpoint values to control units of each infeed system and each infeed system generates setpoint values therefrom and distributes them to the infeed installations of said system.

A central farm control system of this kind is provided for each wind farm. However, it can also be provided for an infeed system that is not a wind farm or that contains a wind farm. It is likewise possible of course for a central farm control system of this kind to be provided for a wind farm that contains still further feeders in addition to wind power installations, such as an electrical store, for example.

In particular, the control of the control center can be coordinated in such a way that a change in the phase angle at the reference point satisfies at least one angle limit criterion. The central coordination can be used in particular to prevent all of the infeed systems or all of the infeed installations reacting individually and thus overreacting overall when the angle limit criterion is reached.

In particular, provision is made for the change in phase angle in terms of magnitude not to exceed a maximum angle value and/or for the change in phase angle in terms of magnitude not to exceed a maximum angle change rate. Accordingly, an absolute limit or as an alternative or in addition a relative limit that prevents too rapid a change can be provided at the reference point. The compliance with these limits can be coordinated centrally in order to achieve accurate and stable infeed.

According to one aspect, it is proposed that a central current reference variable is specified to control the system infeed currents and/or the installation currents, wherein each system infeed current or each installation current is specified depending on said current reference variable. As a result, central control of the infeed currents can be achieved, with the advantages already described above. In this case, it is proposed here in particular to carry out not only central coordination but to specify each individual system infeed current or installation current in a targeted manner. As a result, complete control of the currents and therefore also of the total infeed current is possible. Such a proposal may make it necessary for an increased communication outlay between the units. It is therefore proposed in particular to provide rapid communication links, in particular direct communication paths, whether they be wired or via radio. It has also been identified here that such outlay can still be very low in relative terms in comparison to outlay for changing a network impedance through corresponding updating of the electrical supply network.

The central current reference variable may therefore be a consistent value for all of the infeed systems or infeed installations. For example, it may be a percentage value, which indicates the current to be fed in in relation to the respective nominal current. If the infeed systems or installations have different nominal currents, different absolute current values therefore result despite the same central current reference variable. As a result, an individual current for each infeed system or each infeed installation can be specified in a simple and centrally coordinated manner.

The current reference variable preferably specifies a current phase angle for all system infeed currents and/or for all installation currents. A current phase angle of this kind can have the same value irrespective of the size of the respective infeed system or the respective infeed installation. Therefore, in particular a reactive power component can be controlled centrally overall, that is to say for the total infeed current. Therefore, a reactive power component of this kind can accordingly be implemented precisely.

According to one configuration, it is proposed that the central current reference variable specifies only said current phase angle, whereas the respective level of the system infeed current or installation current is specified in each case individually by the infeed system or the infeed installation. To this end, a central guide variable can nevertheless be output. In particular, and this applies for any embodiments, a voltage in terms of magnitude and phase can be ascertained at the reference node and all of the infeed systems or infeed installations are provided for referencing.

According to one aspect, it is proposed that all system infeed currents of the infeed systems are detected and transmitted as information to the respective other infeed systems, and/or that some or all installation currents of the infeed installations are detected and transmitted as information to some or all infeed installations and/or to the infeed systems so that the system infeed currents and/or the installation currents are each controlled depending on the other system infeed currents or installation currents. It is therefore proposed to detect all of the relevant currents and to exchange the data between the infeed systems or infeed installations. If the installation currents are detected, it may be expedient to transmit these not only to the other infeed installations but also to the infeed systems. The infeed systems can ascertain the respective system infeed current from the relevant installation currents, specifically the system infeed currents of the other infeed systems. One variant is thus that the infeed systems know the system infeed currents of all of the infeed systems only via the detection of the installation currents and accordingly can use same for the control of the system infeed currents.

As a result, correspondingly accurate control is possible, which can achieve stable infeed even in the case of low short-circuit current ratios.

According to one aspect, it is proposed that at least one of the infeed systems, or all of the infeed systems, has, or have, a short-circuit current ratio of less than 2 and/or that all of the infeed systems together have a short-circuit current ratio of less than 2 in relation to the connecting node.

Therefore, the proposed method for feeding in electrical power is expressly used for a configuration with a very low short-circuit current ratio. Therefore, such a configuration can be used effectively, in particular a comparatively large amount of power can be fed in and infeed systems or infeed installations, in particular wind farms and wind power installations, with a comparatively high nominal power can be connected.

However, the method is also advantageous when infeed systems with a correspondingly low short-circuit current ratio are connected but in addition, for example, a further infeed system that does not have such a low short-circuit current ratio is connected. However, this can influence the total infeed current and should therefore be taken into account. The fact that an infeed system does not have a low short-circuit current ratio can also mean in particular that although said infeed system is also connected via a comparatively weak network section, in particular specifically via the same network section as the other infeed systems, it is only of very small dimensions itself. Nevertheless, it should be taken into account.

In particular when the connecting node forms the network connection point for all of the infeed systems, the short-circuit current ratio is preferably related thereto. However, consideration is also given to the fact that the connecting node does not form the common network connection point but is located further into the electrical supply network. The short-circuit current ratio at such a connecting node or referred to such a connecting node may still be relevant. It has been identified in particular that it depends in particular on the design of the common path section between the reference point and the connecting node in order to evaluate and take into account the strength of this connection for the infeed systems. It is therefore proposed to take into account the short-circuit current ratio in relation to said connecting node.

According to one aspect, it is proposed that each one of the system infeed currents and/or each one of the installation currents is jointly controlled additionally depending on at least one further feeder, which feeds an infeed current into the common path section, and/or depending on at least one consumer, which receives a consumption current from the common path section. In this case, it has been identified in particular that a further feeder of this kind and/or a consumer of this kind can influence the total infeed current, that is to say the current on a transmission section between the connecting node and the reference point. That is to say if these additional currents that flow in or out are not taken into account, the voltage at the reference point cannot be detected or can be detected only with a corresponding degree of inaccuracy. This would result in the reference point having to be shifted in the direction toward the connecting node, in particular so far that said additional currents flowing in or out no longer have an influence.

However, it has been identified that the proposed method functions particularly well the further the reference point is arranged toward a network focal point. It is therefore proposed to shift said reference point as far as possible toward such a network focal point and this is made possible by virtue of the fact that in addition currents flowing in or out that become relevant as a result are taken into account.

According to one aspect, it is proposed that a network node is selected as reference point, said network node being as close as possible to a network focal point, and the voltage and phase angle of said node being able to be calculated depending on the infeed currents and/or installation currents and optionally further known currents flowing in or out between the connecting node and the reference node. The network focal point describes a node in the electrical supply network at which an average phase angle, which exhibits the smallest difference from all of the phase angles of the electrical supply network, occurs.

This description or definition is thus to be understood as meaning that an electrical supply network has a very large number of network nodes that can all have different phase angles. In this case, a phase angle of the network voltage that is assumed in relation to a reference angle is meant.

The reference angle can float, the respective phase angles of the individual network nodes can also float, but a fixed value results in each case as the difference between the phase angles because the network frequency is the same. This applies at least for a stationary case.

As seen from the network focal point, in simplified terms, the phase angles of network nodes are greater in one direction than at the network focal point, in particular become greater as the distance increases, whereas phase angles in another direction become smaller. This results in at least one network node with a maximum phase angle and another with a minimum phase angle. These two nodes have the greatest phase angle difference. The network focal point is then the one at which the phase angle is located exactly in the middle between the mentioned greatest and mentioned smallest phase angles. All of the other network nodes that do not have the same phase angle as the network focal point therefore have a greater difference either from the maximum phase angle or from the minimum phase angle. Consideration is also given to the fact that the network focal point is designed as a line, also possible as a ring. All the network nodes on this line then have the same phase angle. This does not change anything in the assessment of how close a node is to the network focal point because it depends here on the difference in the phase angles between the network focal point and the reference point.

As close as possible to the network focal point means that the difference in the phase angles between the network focal point and the reference point is as low as possible. This then makes it possible to achieve a situation in which the infeed method can be controlled in as stable a manner as possible. In particular, the closer the reference point is to the network focal point, the more stable it is and the better suited it is as reference value as a result.

In particular, the infeed systems and/or the infeed installations are preferably controlled in such a way that they refer to the reference point, that is to say to the voltage detected or calculated at the reference point in terms of magnitude and phase.

However, it has also been identified that the ideal case, specifically that the reference point corresponds to the network focal point, cannot necessarily be realized. It is therefore attempted to bring the reference point as close to the network focal point as possible but just so close that the voltage and phase angle can be calculated. This is in particular no longer possible when currents that flow in or out can no longer be detected sufficiently. This is the case, for example, when a large feeder feeds in or a large consumer consumes and values thereof cannot be detected or cannot be detected with an acceptable level of outlay.

An infeed arrangement is proposed. Said infeed arrangement comprises a plurality of infeed systems for feeding electrical power into an electrical supply network, wherein an infeed system is designed as an individual infeed installation, in particular as a wind power installation, or as an infeed farm having a plurality of infeed installations, in particular as a wind farm having a plurality of wind power installations, each infeed system is prepared to feed a system infeed current into the electrical supply network in each case via a connection node, each infeed installation is prepared to output an installation current, a system infeed current corresponds to an installation current, or is composed of a plurality of installation currents, depending on how many infeed installations the respective infeed system has,

a respective system transmission path for transmitting electrical power is present between each of the infeed systems and a reference point in the electrical supply network, with the result that, when infeed is carried out, the respective system infeed current is transmitted on each system transmission path,

a respective installation transmission path for transmitting electrical power is present between each of the infeed installations and the reference point in the electrical supply network, with the result that, when infeed is carried out, the installation current is transmitted on each installation transmission path,

the system transmission paths have a common path section between a connecting node and the reference point, on which common path section the system infeed currents add up to form a total infeed current,

each infeed system is prepared to control its system infeed current depending on a phase angle shift and/or a voltage drop between the infeed system and the reference point, and/or each infeed installation is prepared to control its installation current depending on a phase angle shift and/or a voltage drop between the infeed installation and the reference point, wherein the infeed arrangement is prepared for the phase shift or the voltage drop to be ascertained in each case depending on the total infeed current.

Each infeed system is in particular prepared thereby to feed a system infeed current into the electrical supply network in each case via a connection node by virtue of the fact that it is connected to the respective connection node. In addition, the infeed system may have corresponding converters or inverters for infeed. Consideration is also given to the fact that an infeed system can feed in by means of the one or more infeed installations.

The infeed installations are prepared to output an installation current by virtue of the fact that they have corresponding inverters or converters that generate such an installation current. In this respect, the installation current can also be considered as an output current of the infeed installations. If there are a plurality of infeed installations present in an infeed system, the installation currents can be superposed, in particular added, within the infeed system at corresponding nodes in the infeed system in order to form the system infeed current.

A system transmission path and also an installation transmission path do not have to be part of the infeed system but may be part of the infeed system, at least in part. In any case, however, the control of a respective system infeed current and/or a respective installation current depends on said system transmission paths or installation transmission paths or the currents respectively transmitted there. These paths, or at least the currents flowing there, are therefore taken into account.

The fact that in this case the infeed system is prepared to control its system infeed current depending on a phase angle shift and/or a voltage drop between the infeed system and the reference point involves in particular recording corresponding values of the phase angle shift or of the voltage drop. It also involves the corresponding control system being prepared to process corresponding information. In particular, a corresponding control program can be implemented.

The same applies to each infeed installation, which is prepared to control its installation current depending on a phase angle shift and/or a voltage drop between the infeed installation and the reference point. To this end, a corresponding control system can be provided, which may be implemented and records corresponding input values and controls the installation current accordingly depending thereon.

The fact that the infeed arrangement is prepared for the phase angle shift or the voltage drop to be ascertained in each case depending on the total infeed current can be achieved by way of a correspondingly implemented control method. The control method includes this functionality. This may include in particular detecting a corresponding total infeed current, for example by way of corresponding measurements or correspondingly obtained measurement signals, or it can be ascertained from other values. Such other values may be values of the individual system infeed currents and/or the individual installation currents. In principle, consideration is also given to another ascertainment, for example by way of corresponding measurement of voltages at different points.

Provision is made in particular for each infeed system or each infeed installation to operate as described in order to exploit the potential described herein as fully as possible but if not all of said infeed systems or infeed installations are involved, an advantageous effect can still be achieved by the others that implement the method. In this case, where possible, the currents of the infeed systems or infeed installations that are not involved should also be taken into account.

Infeed systems and/or infeed installations that are each involved and therefore execute the steps that involved infeed systems or infeed installations execute are therefore also proposed. According to one aspect, it is proposed that an infeed control device (e.g., infeed controller) is provided for the infeed arrangement. The infeed is controlled by means of said infeed control device when the infeed arrangement is accordingly in operation. The infeed control device can to this end comprise a central control unit and in addition or as an alternative it can be realized by a plurality of local control units (e.g., local controllers) of the infeed systems and/or of the infeed installations, said local control units being prepared to communicate with one another. In one case, they are realized by way of the central control unit, which coordinates the proposed infeed and to this end communicates with the infeed systems and/or infeed installations. For this purpose, setpoint values can be output by the central control unit and preferably measurement values can also be received. The measurement values can come from external or additional detection devices. However, measurement values can also originate from the infeed systems and/or the infeed installations. Particularly when the latter detect values such as the respectively generated installation current or system infeed current anyway, these values can be transmitted to the central control unit.

Instead, the infeed control device can be structured in a decentralized manner by virtue of each infeed system and/or each infeed installation controlling the respective system infeed current or installation current itself, but in the process taking into account the other system infeed currents and/or installation currents, whether this be directly or indirectly.

Consideration is also given to a combination in which the central control unit is provided and specifies some setpoint values, for example a system infeed current or installation current as a percentage. The infeed systems or infeed installations can be guided thereby, but automatically react in the case of rapid voltage changes. In other words, the central control unit can specify setpoint values for stationary operation, wherein the individual infeed systems or infeed installations can deviate therefrom in a transient process and be guided here independently by the relevant phase shift and/or the relevant voltage drop.

In addition, provision is made for the infeed control device to be prepared to carry out a method according to one of the embodiments of the method for infeed described above. Corresponding control can also be implemented for this purpose in the infeed control device.

An infeed system, in particular a wind farm, is also proposed, which is prepared to execute a method according to one of the above embodiments and/or which is prepared for use as an infeed system of an infeed arrangement of one of the above embodiments. The infeed system therefore uses or includes the features described respectively for the infeed system.

An infeed installation, in particular a wind power installation, is also proposed, which is prepared to execute a method according to one of the above embodiments and/or which is prepared for use as an infeed installation of an infeed arrangement of one of the above embodiments. The infeed installation therefore uses or includes the features described respectively for the infeed installation.

### BRIEF DESCRIPTION OF THE SEVERAL VIEWS OF THE DRAWINGS

The invention is now explained in more detail below by way of example based on embodiments with reference to the accompanying figures.

FIG. 1 shows a perspective illustration of a wind power installation.

FIG. 2 shows a schematic illustration of a wind farm.

FIG. 3A shows an infeed arrangement.

FIG. 3B shows a voltage vector diagram associated with FIG. 3A.

FIG. 4 shows an infeed arrangement according to FIG. 3A with further details.

### DETAILED DESCRIPTION

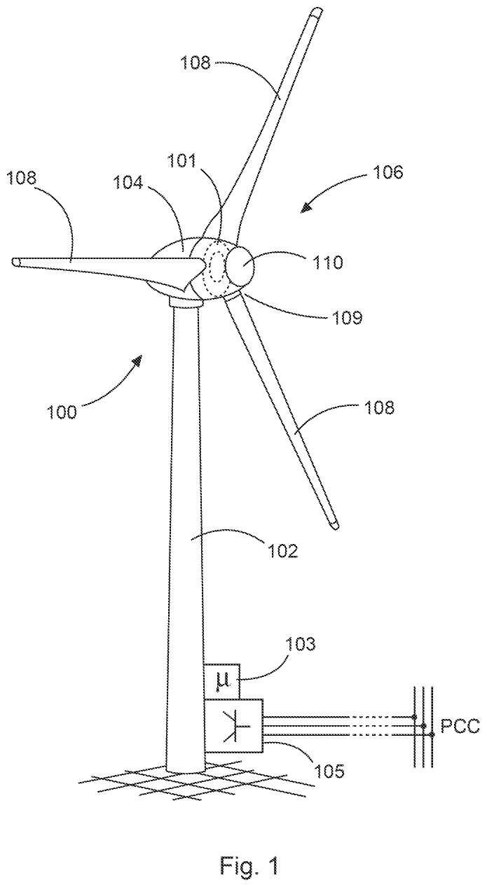

FIG. 1 shows a schematic illustration of a wind power installation. The wind power installation 100 has a tower 102 and a nacelle 104 on the tower 102. An aerodynamic rotor 106 having three rotor blades 108 and having a spinner 110 is provided on the nacelle 104. During the operation of the wind power installation, the aerodynamic rotor 106 is set in rotational motion by the wind and thereby also rotates an electrodynamic rotor of a generator, which is coupled directly or indirectly to the aerodynamic rotor 106. The electric generator is arranged in the nacelle 104 and generates electrical energy. The pitch angles of the rotor blades 108 may be varied by pitch motors at the rotor blade roots 109 of the respective rotor blades 108.

The wind power installation 100 in this case has an electric generator 101, which is indicated in the nacelle 104. Electric power is able to be generated by way of the generator 101. Provision is made for an infeed unit 105, which may be designed in particular as an inverter, to feed in electric power. It is thus possible to generate a three-phase infeed current and/or a three-phase infeed voltage in terms of amplitude, frequency and phase, for infeed at a network connection point PCC.

This may be performed directly or else together with other wind power installations in a wind farm. Provision is made for an installation control system 103 for controlling the wind power installation 100 and also the infeed unit 105. The installation control system 103 may also receive predefined values from an external source, in particular from a central farm computer. The installation control system 103 may form or contain a local control unit.

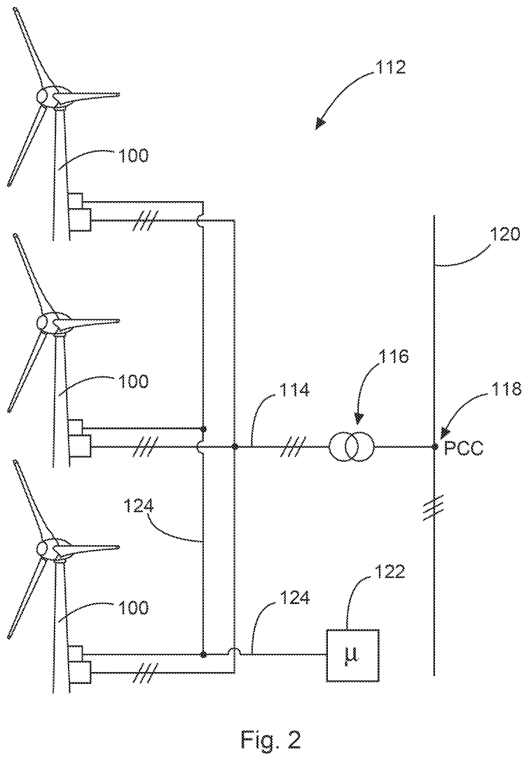

FIG. 2 shows a wind farm 112 having, by way of example, three wind power installations 100, which may be identical or different. The three wind power installations 100 are thus representative of basically any desired number of wind power installations of a wind farm 112. The wind power installations 100 provide their power, specifically in particular the generated current, via an electrical farm network 114. In this case, the respectively generated currents or powers of the individual wind power installations 100 are added together and a transformer 116, which steps up the voltage in the farm, is usually provided in order to then feed into the supply network 120 at the infeed point 118, which is also generally referred to as a PCC or network connection point. FIG. 2 is only a simplified illustration of a wind farm 112. By way of example, the farm network 114 may also be designed in another way by virtue of for example a transformer also being present at the output of each wind power installation 100, to mention just one other exemplary embodiment.

The wind farm 112 additionally has a central farm computer 122, which can also be referred to synonymously as central farm control system. This may be connected, via data lines 124 or wirelessly, to the wind power installations 100 in order to interchange data with the wind power installations via this connection and, in particular, to receive measured values from the wind power installations 100 and transmit control values to the wind power installations 100. The central farm computer 122 or the central farm control system (e.g., central farm controller) may form or contain a local control unit (e.g., local controller) of the wind farm, form an infeed control device (e.g., infeed controller) for an infeed arrangement, or be part of an infeed control device.

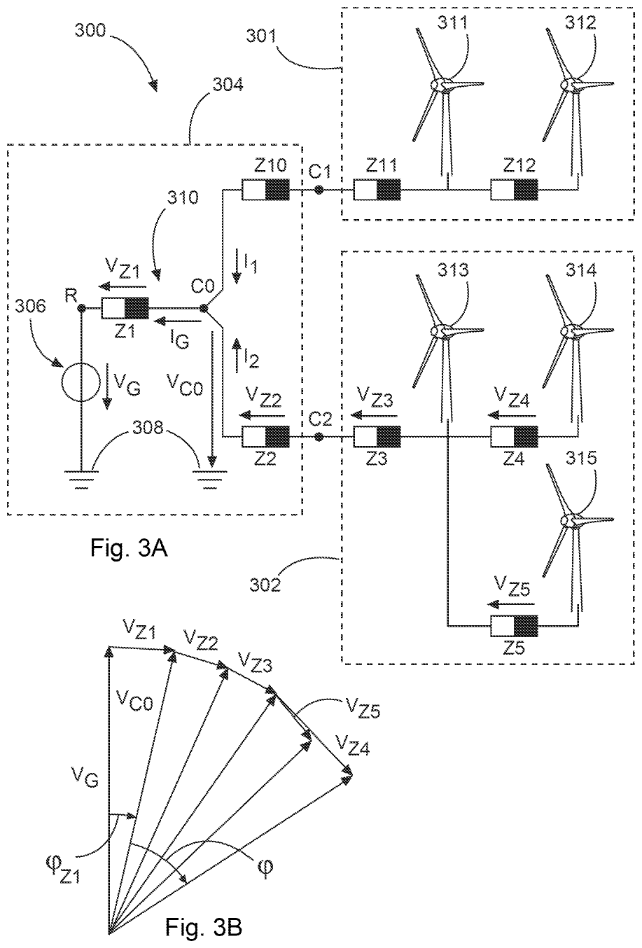

FIG. 3A shows an infeed arrangement 300 having a first infeed system 301 and a second infeed system 302. Both infeed systems 301 and 302 are designed as wind farms having by way of example a total of five wind power installations 311 to 315. Both wind farms 301 and 302 feed into an electrical supply network 304 in each case via a connection node C1 or C2. The connection nodes C1 and C2 can therefore each be understood as a network connection point. They can be considered as part of the respective infeed system 301 or 302 or as part of the electrical supply network 304. The electrical supply network is represented here substantially by the voltage source 306 for the sake of simplicity. The voltage source 306 has a network voltage VG, which is thus 30 applied between the reference point R and the electrical ground 308. Said network voltage is variable and this can also depend on a behavior of the electrical supply network 304, which is represented here at least in part by said voltage source.

Furthermore, a connecting node C0, at which system infeed currents I₁ and I₂ of the first and second infeed system 301 and 302 are superposed, specifically added, is present. A common path section 310 is present between the connecting node C0 and the reference point R and is characterized in electrical terms by the network impedance Z1. A connecting node voltage V_{C0} is applied between the connecting node C0 and the electrical ground 308.

A common total infeed current IG, which is made up of the exemplary system infeed currents I₁ and I₂, flows via the common path section 310 and thus via the network impedance Z1. The voltage V_{z1} at the network impedance Z1 can therefore be determined.

The first infeed system 301 therefore feeds in at the connection node C1 via the impedance Z10 and the impedance Z1 up to the reference point R. This route from the connection node C1 up to the reference point R is the system transmission path of the first infeed system and is characterized by the impedances Z10 and Z1. The second infeed system 302 accordingly feeds into the electrical supply network at the second connection node C2 and the route from the second connection node C2 up to the reference point R is therefore the system transmission path of the second infeed system 302. Said system transmission path is characterized by the impedances Z1 and Z2. The common path section 310 is therefore part of the system transmission paths of the first and second infeed system.

The wind power installations 311 to 315, which therefore each form an infeed installation, each supply an installation current via an installation transmission path. The installation transmission path runs via the impedances Z11, Z10 and Z1 for the wind power installation 311, via the impedances Z12, Z11, Z10 and Z1 for the wind power installation 312, via the impedances Z3, Z2 and Z1 for the wind power installation 313, via the impedances Z4, Z3, Z2 and Z1 for the wind 25 power installation 314 and via the impedances Z5, Z3, Z2 and Z1 for the wind power installation 315.

The common path section 310 is therefore also a common path section for the mentioned installation transmission paths.

It is desirable for the infeed of the infeed systems 301 and 302 to be guided by the network 30 voltage V_{G}. When the second infeed system 302 feeds in via the impedance Z2 and this impedance is known, the connecting node voltage Vco can be detected, specifically from the voltage at the second connection node C2, the second system infeed current 12 and the knowledge of the impedance Z2. However, in order to ascertain the voltage at the reference point R, the voltage V_{Z1} must also be known. If the network impedance Z1 and the current across said network impedance Z1 are known, the voltage V_{Z1} could be ascertained. However, the current across the network impedance Z1, specifically the total infeed current, is made up of the two system infeed currents I₁ and I₂.

It is therefore proposed that the second infeed system 302 also takes the first infeed current of the first infeed system 301 into account or at least takes the effects thereof on the network impedance Z1 into account. As a result, it is then possible for the second infeed system, which is considered here by way of example, to be able to accurately detect the network voltage V_{G} at the reference point. The infeed can then be guided by said network voltage V_{G}. Said network voltage V_{G} is better suited as reference voltage than the connecting node voltage V_{C0}. In particular, it has been identified that the reference point R should be set as far into the electrical supply network as possible, that is to say as close as possible to a network focal point. It is thus selected to be so close to the network focal point that information about the currents of a corresponding impedance particularly from the connecting node C0 to the reference point R is still sufficiently known or can be detected.

It is often possible to feed into an infeed system, in particular a wind farm, by way of the individual infeed installations, that is to say by way of the individual wind power installations. The individual impedances in the wind farm, in this case specifically the impedances Z3, Z4 and Z5 in the second infeed system, are usually known. Furthermore, the respective installation currents of the wind power installations 313 to 315 are known and therefore the respective voltages at the impedances Z3 to Z5 can be ascertained. Given additional knowledge of the impedance Z2 between the connection node C2 and the connecting node C0, each of the wind power installations 313 to 315 can therefore ascertain the connecting node voltage V_{C0} at the connecting node C0. Said voltage could be used as reference voltage, with which the infeed is aligned, that is to say by which the infeed is guided. However, it would be better to use the network voltage V_{G} at the reference point R. However, additional information is necessary for this, specifically in particular the first system infeed current I1 of the first infeed system 301. It is proposed to take exactly this into account.

In this case, the voltage ratios are shown in the voltage vector diagram of FIG. 3B. The 30 network voltage V_{G} and the connecting node voltage Vco are shown in the voltage vector diagram.

Said voltages differ by the voltage Vzi across the network impedance Z1. In particular, a phase angle shift results at the network impedance Z1, which in particular has a comparatively low ohmic component. Depending on the line construction, the network impedance Z1 may have in particular a high inductive component. The same also applies to the other impedances Z3 to Z5 and otherwise also to Z10 to Z12, which are not taken into account in the diagram, however. The phase shift, caused by the network impedance Z1, is shown in the diagram as φ_{Z1}. A further phase angle φ is shown symbolically, which reflects the total phase shift across the impedances Z2, Z3 and Z4. A phase shift results at each impedance; however, for reasons of clarity, these further phase shifts are not shown as extra.

In any case, it can be seen that a reference to the connecting node C0 can be significantly improved by a reference to the reference point R. As a result, in particular the shown phase angle φ_{Z1} can additionally be taken into account.

The result is therefore an improved possibility of aligning the infeed with the network voltage V_{G} at the reference point R.

The solution presented is particularly important for operation at extremely weak connection points, which can be improved in particular by stable knowledge of the reference, that is to say the network voltage V_{G} at the reference point R. Operation of infeed systems, in particular wind farms, at extremely weak network connection points is therefore possible. Such network connection points can then have a short-circuit current ratio <2. In relation to FIG. 3A, a respective short-circuit current ratio <2 can therefore be present at the connection node C2 and also the connection node C1.

A low short-circuit current ratio <2 of this kind is also possible and proposed for the connecting node C0. A short-circuit current ratio at the connecting node C0 is one for which the nominal power of both infeed systems 301 and 302 together is taken as a basis. The short-circuit current ratio of the connecting node C0 is therefore the ratio of the power that can be provided in the case of a short circuit at the connecting node C0 with respect to the sum of the nominal powers of the two infeed systems 301 and 302. Said short-circuit power is therefore that power that results from the network voltage VG, when it has a nominal voltage, and the network impedance Z1 shown.

In particular, it has been identified that, from the point of view of an individual wind power installation or else a wind farm, in this case particularly one of the wind power installations 311 to 315 or one of the wind farms 301 and 302, the phase shift can be determined by the separate current up to a particular location in the network. This particular location is the connecting node C0. In this case, it has been identified that this is possible so far into a network, specifically in the direction of the network focal point, as long as the node currents are known. This is illustrated here at the two system infeed currents I₁ and I₂, which therefore form the node currents for the connecting node C0.

In the example of FIG. 3A, the second infeed system 302, that is to say the second wind farm 302, can therefore determine the connecting node voltage V_{C0} at the connecting node C0 when all of the currents of the individual wind power installations 313 to 315 and the impedances Z3 to Z5 are known. Individual wind power installations can therefore also determine the voltage or phase shift in each case to the next node at which an additional infeed or load acts when the network impedance is known. The voltage or phase shift can thus be determined up to such a node until an 10 additional infeed or load arises that is no longer known.

It has therefore been identified that, when the reference voltage is determined, specifically in particular the voltage at the reference point, the separate phase shift can be calculated therefrom, with the result that the current is fed in based on the phase position and frequency of a further remote voltage. This can be done for the current vector generation of the individual wind power installation and even for an entire wind farm. FIG. 3A is intended to illustrate both variants.

In the event of control at the wind farm level, it is proposed to create a central voltage reference from the impedances and the node currents, said central voltage reference being communicated with the individual wind power installations. Via the phase offset with respect to the separate measured voltage and the power fed in, it is also possible to infer the current phase angle sensitivity and the control can be adjusted accordingly. It is thus not only the voltage reference to which the infeed can be adjusted that can be ascertained but it is also possible to infer the current phase angle sensitivity.

In principle, the phase angle sensitivity can form a measure here of how sensitively the reference voltage reacts to changes in the power fed in. This may be taken into consideration in the control. In particular, the control can be adjusted accordingly in terms of its gain. In particular, if a great phase angle sensitivity is identified, the control can be adjusted to be correspondingly weaker in order to prevent an overreaction in the case of voltage changes, in particular changes in the angle shift or the phase angle.

The central generation of a current reference depending on the desired power is preferably proposed. For this purpose, it is proposed in particular to provide rapid communication between a central control unit and the individual wind power installations. Target currents of the individual wind power installations can then be specified centrally. Central current vector generation can therefore be provided.

In addition or as an alternative, it is proposed to transmit all of the node currents to each of the other wind power installations. The node currents are therefore the currents that the wind power installations generate and that add up to form relevant currents. In particular, the installation currents can each be considered as node currents. Values of these node currents or installation currents can be transmitted within the respective wind farm, but also overall between the wind farms, that is to say between the infeed systems 301 and 302. Values of the installation currents are preferably each exchanged between the wind power installations within the wind farm and values of the respective summation currents, that is to say each of the system infeed currents, are exchanged additionally between the wind farms.

Each wind power installation itself can then determine the current operating point of the wind farm network and the other wind power installations and also adjust the separate control thereto. In this variant, it is possible to omit very rapid communication because the current reference is generated individually at each wind power installation and only the operating points of the other wind power installations that are slower to be transmitted are taken into account. Each wind power installation thus generates its own current vector for infeed, wherein, however, the wind power installation takes into account only the effective values of the respective installation currents from the other wind power installations, to express it simply.

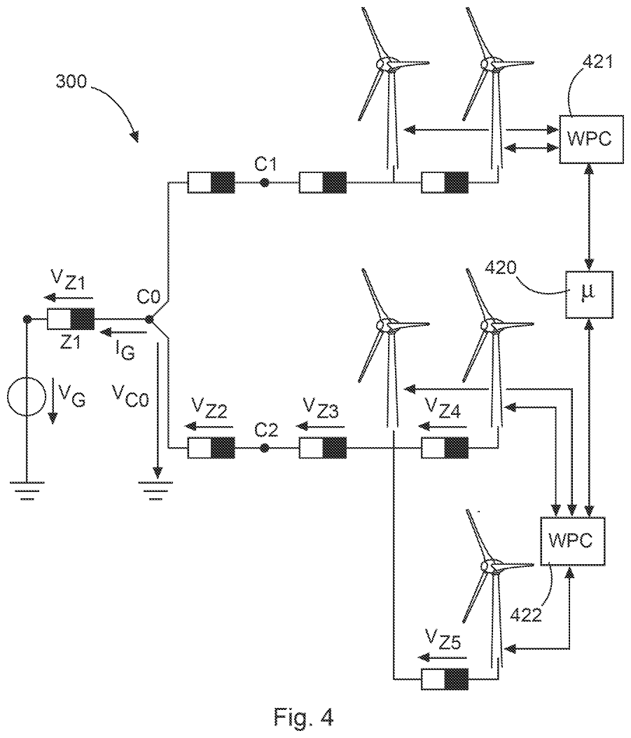

The infeed arrangement 300 of FIG. 3A is fundamentally illustrated once more identically in FIG. 4, wherein in addition communication elements and control elements are shown. In particular, a central control unit (e.g., central controller) 420 is proposed. The central control unit 420 can communicate bidirectionally in each case with a central farm control system 421 and 422. Each central farm control system can then communicate in turn with the individual wind power 25 installations of the wind farm. This is also provided to be bidirectional. As a result, the individual wind power installations can transmit measurement values, in particular via their output installation currents, to the respective central farm control system (e.g., central farm controller) 421 or 422 and these values can be transmitted to the central control unit 420. The central control unit 420 can in turn collect all of these values centrally and transmit the respectively required values to the central 30 park control systems 421 and 422, from which they are distributed to the individual wind power installations 311 to 315.

This is one possible topology of an infeed control device. In this case, the central control unit 420 forms together with the central farm control systems 421 and 422 the infeed control device. However, consideration is also given to other topologies, for example that the central control unit communicates directly with each wind power installation. Consideration is also given to all of the wind power installations being connected to one another via a corresponding data system.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to 10 include all possible embodiments along with the full scope of equivalents to which such claims are entitled. Accordingly, the claims are not limited by the disclosure.

1. A method for feeding electrical power into an electrical supply network using a plurality of infeed systems,
wherein:
an infeed system of the plurality of infeed systems is an individual infeed installation or an infeed farm having a plurality of infeed installations,
each infeed system of the plurality of infeed systems feeds a system infeed current of a plurality of system infeed currents into the electrical supply network at a connection node, of a plurality of connection nodes, associated with the infeed system,
each infeed installation of the plurality of infeed installations outputs an installation current of a plurality of installation currents,
the system infeed current corresponds to the installation current or is made up of the plurality of installation currents based on a number of the plurality of infeed installations,
a respective system transmission path for transmitting electrical power is coupled between each infeed system of the plurality of infeed systems and a reference point in the electrical supply network,
a respective installation transmission path for transmitting electrical power is coupled between each infeed installation of the plurality of infeed installations and the reference point in the electrical supply network, and
a plurality of system transmission paths have a common path section between a connecting node and the reference point, and
wherein the method comprises:
carrying a respective system infeed current on each system transmission path of the plurality of system transmission paths;
carrying a respective installation current on each installation transmission path of a plurality of installation transmission paths;
adding the plurality of system infeed currents on the common path section to form a total infeed current;
controlling, by at least one infeed system, the respective system infeed current of the at least one infeed system depending on a phase angle shift and/or a voltage drop between the at least one infeed system and the reference point, and/or controlling, by at least one infeed installation, the respective installation current of the at least one infeed installation depending on a phase angle shift and/or a voltage drop between the at least one infeed installation and the reference point; and
determining the phase angle shift or the voltage drop for the at least one infeed system or the at least one infeed installation depending on the total infeed current.

2. The method as claimed in claim 1, wherein the individual infeed installation is a wind power installation or the infeed farm is a wind farm having a plurality of wind power installations.

3. The method as claimed in claim 1, wherein:
each connection node is a network connection point, and/or
operation of the at least one infeed system or the at least one infeed installation is controlled by converters and/or is performed in a current-impressing manner.

4. The method as claimed in claim 1, wherein controlling, by the at least one infeed system, the respective system infeed current depending on the phase angle shift and/or the voltage drop includes each infeed installation of the at least one infeed system controlling the respective installation current of the infeed installation depending on a phase angle shift and/or a voltage drop between the infeed installation and the reference point.

5. The method as claimed in claim 1, comprising:
exchanging information about the plurality of system infeed currents between the plurality of infeed systems to detect the phase angle shift or the voltage drop depending on the total infeed current;
exchanging information about the plurality of installation currents between the plurality of infeed installations to detect the phase angle shift or the voltage drop depending on the total infeed current; and/or
detecting the total infeed current metrologically to detect the phase angle shift or the voltage drop depending on the total infeed current.

6. The method as claimed in claim 1, comprising:
determining a phase angle sensitivity for each infeed system and/or each infeed installation, wherein the phase angle sensitivity indicates a ratio between a change in the system infeed current or the installation current and a resulting phase angle shift; and
controlling the system infeed current or the installation current depending on the respectively detected phase angle shift and the respectively determined phase angle sensitivity.

7. The method as claimed in claim 6, wherein
the system infeed current or the installation current is controlled depending on the phase angle shift using current control having a controller gain, and
the controller gain is reduced in magnitude as the phase angle sensitivity increases.

8. The method as claimed in claim 1, wherein:
the system infeed current and/or the installation current is controlled such that the phase angle shift satisfies at least one shift limit criterion.

9. The method as claimed in claim 8, wherein:
a magnitude of the phase angle shift does not exceed a shift maximum value; and/or
the magnitude of the phase angle shift does not exceed a maximum shift rate of change.

10. The method as claimed in claim 1, comprising:
centrally coordinating control of the plurality of system infeed currents and/or the plurality of installation currents such that:
a phase angle change at the reference point satisfies at least one angle limit criterion,
a magnitude pf the phase angle change does not exceed an angle maximum value; and/or
the magnitude of the phase angle change does not exceed a maximum angle rate of change.

11. The method as claimed in claim 1, wherein:
a central current reference variable is specified to control the plurality of system infeed currents and/or the plurality of installation currents,
each system infeed current of the plurality of system infeed currents or each installation current of the plurality of installation currents is specified depending on the central current reference variable, and
the central current reference variable specifies a current phase angle for the plurality of system infeed currents and/or the plurality of installation currents.

12. The method as claimed in claim 1, wherein:
the plurality of system infeed currents are detected and transmitted as information to respective other infeed systems, and/or
at least a portion of the plurality of installation currents of the plurality of infeed installations are detected and transmitted as information to some or all of the plurality of infeed installations and/or the plurality of infeed systems such that the plurality of system infeed currents and/or the plurality of installation currents are each controlled depending on the other of the plurality of system infeed currents or the plurality of installation currents.

13. The method as claimed in claim 1, wherein:
at least one of the plurality of infeed systems has a short-circuit current ratio of less than 2, and/or
the plurality of infeed systems together in relation to the connecting node have a short-circuit current ratio of less than 2.

14. The method as claimed in claim 1, wherein:
each one of the plurality of system infeed currents and/or each one of the plurality of installation currents is controlled depending on:
at least one further feeder that feeds an infeed current into the common path section, and/or
at least one consumer that receives a consumption current from the common path section.

15. The method as claimed in claim 14, wherein a change in a phase angle at the reference point is taken into account and determining the phase angle shift is performed depending on the change in the phase angle at the reference point.

16. The method as claimed in claim 1, wherein:
a network node is selected as the reference point,
the network node is proximate a network focal point, wherein the network focal point represents a node in the electrical supply network at which an average phase angle, which exhibits a smallest difference from all of phase angles of the electrical supply network, occurs, and
the voltage and phase angle of the network node are calculated depending on the plurality of system infeed currents and/or the plurality of installation currents.

17. An infeed arrangement, comprising:
a plurality of infeed systems configured to feed electrical power into an electrical supply network, wherein an infeed system of the plurality of infeed systems is an individual infeed installation or an infeed farm having a plurality of infeed installations, wherein:
each infeed system of the plurality of infeed systems is configured to feed a system infeed current of a plurality of system infeed currents into the electrical supply network via a connection node, of a plurality of connection nodes, associated with the infeed system,
each infeed installation of the plurality of infeed installations is configured to output an installation current of a plurality of installation currents,
the system infeed current corresponds to the installation current or is made up of the plurality of installation currents based on a number of the plurality of infeed installations,
a respective system transmission path for transmitting electrical power is coupled between each infeed system of the plurality of infeed systems and a reference point in the electrical supply network, and a respective system infeed current is transmitted on each system transmission path,
a respective installation transmission path for transmitting electrical power is coupled between each infeed installation of the plurality of infeed installations and the reference point in the electrical supply network, and a respective installation current is transmitted on each installation transmission path,
a plurality of system transmission paths have a common path section between a connecting node and the reference point, and the plurality of system infeed currents are added to form a total infeed current on the common path section,
at least one infeed system controls the respective system infeed current of the at least one infeed system depending on a phase angle shift and/or a voltage drop between the at least one infeed system and the reference point, and/or at least one infeed installation controls the respective installation current of the at least one infeed installation depending on a phase angle shift and/or a voltage drop between the infeed installation and the reference point, and
the infeed arrangement is configured to determine the phase angle shift or the voltage drop for the at least one infeed system or the at least one infeed installation depending on the total infeed current.

18. The infeed arrangement as claimed in claim 17, wherein the individual infeed installation is a wind power installation or the infeed farm is a wind farm having a plurality of wind power installations.

19. The infeed arrangement as claimed in claim 17, comprising:
an infeed controller configured to control the infeed of the electrical power, wherein the infeed controller includes a central controller and/or includes a plurality of local controllers of the plurality of infeed systems and/or the plurality of infeed installations, wherein the plurality of local controllers communicate with each other.

20. The infeed arrangement as claimed in claim 17, wherein the infeed system is a wind farm.

21. The infeed arrangement as claimed in claim 17, wherein the infeed installation is a wind power installation.
